(19) United States
(12) Patent Application Publication
(10) Pub. No.: US 2013/0328700 A1
(43) Pub. Date: Dec. 12, 2013

(54) ACTIVE REAL-TIME TRAFFIC MANAGEMENT SYSTEM

(71) Applicants: Amr IBRAHIM, Calgary (CA); Ahmed ABDELWAHAB, Calgary (CA)

(72) Inventors: Amr IBRAHIM, Calgary (CA); Ahmed ABDELWAHAB, Calgary (CA)

(21) Appl. No.: 13/491,202

(22) Filed: Jun. 7, 2012

(51) Int. Cl. G08G 1/095

(52) U.S. Cl. 340/907

(57) ABSTRACT

There is disclosed an intelligent, automated real-time traffic management system and method for controlling traffic in remote areas. A plurality of positionable controller nodes are positioned in dependence upon a traffic configuration in a given area of interest. The plurality of controller nodes are adapted to communicate wirelessly with each other and with a control center to control traffic within an area of interest based on the traffic configuration and the vehicular traffic. The controller nodes automatically detect approaching and departing traffic in multiple directions and effectively generate a right-of-way sequence resulting in a safe, efficient, and incident free traffic flow through a remotely located hazardous traffic area. The locations of the plurality of controller nodes are tracked utilizing satellite tracking to deploy, provision, and manage a large group of controller nodes from a remotely located control center.

### TECHNICAL FIELD

The present disclosure relates to a real-time traffic management system and method, and more particularly to a system and method for controlling the same.

### BACKGROUND

As the demand for resources increases year over year, industries such as the oil and gas have realized a substantial increase in exploration, drilling, and production activities in remote locations. To extract oil and natural gas from the ground, private roads are built to provide the necessary transportation infrastructure for companies to gain access to these remote sites where exploration for new resources is taking place. In addition, government restrictions have imposed greater challenges and pressure on the industry to minimize the environmental impact. Specifically, stringent guidelines and regulations—in particular relating to project roads and access size restrictions—have been imposed on oil and gas exploration companies, often resulting in roads too narrow to comfortably accommodate two-way traffic. Further, given that such project roads are carved through natural landscapes such as hills and blind corners, according to government statistics, vehicle related incidents are the highest contributor to equipment loss or damage, injuries, and fatalities on these remote roads.

Currently, the industry deals with this imminent danger in a reactive rather than proactive manner, and utilizes one method or a combination of methods that have proven to be ineffective in reliably reducing the accident rate and mitigating such hazardous situations. One such method is achieved by radio-controlling roads, which naturally depends on drivers following the proper protocols and is therefore susceptible to human error or misuse. Usage of road signs to alert drivers of upcoming hazardous hills or corners is another commonly used passive method, however, passive signs do not indicate if a true hazard in the form of an immediately oncoming vehicle exists.

Solar-powered traffic signals are yet another form of prior art. However, they are almost exclusively used in construction projects, such as highway construction, and rarely used in industries such as oil and gas, mining, or forestry. These signals are often timer-based or remotely and manually activated by a nearby crewmember who oversees the two-way traffic. Thus, they require full-time operators and/or ineffective time-based control of traffic, thus resulting in a significant lack of operational efficiency. Requiring traffic to stop when no opposing traffic is present, and relying on crewmember presence in geographically remote areas are major causes for non-adoption of existing solutions by time sensitive industries such as oil & gas, forestry, and mining.

What is needed is a solution that addresses at least some of the limitations as outlined above.

### SUMMARY

The present disclosure relates to a real-time traffic management system and method, and more particularly to a system and method for controlling the same.

A plurality of positionable controller nodes are positioned in dependence upon a traffic configuration in a given area of interest. The plurality of controller nodes are adapted to communicate wirelessly with each other and/or with a remote control center to control traffic within an area of interest based on the traffic configuration and the vehicular traffic. The controller nodes automatically detect approaching and departing traffic in multiple directions and effectively generate a right-of-way sequence resulting in a safe, efficient, and incident free traffic flow through a remotely located hazardous traffic area. The locations of the plurality of controller nodes are tracked utilizing satellite tracking to deploy, provision, and manage a large group of controller nodes from a remotely located control center.

In an aspect, there is provided a fully automated traffic management system and method that is designed to proactively and efficiently manage traffic through hazardous project roads in order to minimize vehicle related incidents.

In an embodiment, the system and method utilizes a plurality of roadside collision avoidance system (R-CAS) units which utilize sensors to detect oncoming traffic in multiple directions. The R-CAS units detect the speed of oncoming vehicles, and also count the number of vehicles going into and out of a control area.

In an embodiment, the R-CAS units further comprise hardware and software adapted to execute control software and provide wireless communications between the R-CAS units such that the units are in communication with other R-CAS units in an area of interest requiring traffic control. The communication between these R-CAS units allows the R-CAS units to coordinate control of traffic through a traffic control zone, such as an intersection, a narrow section of road or a narrow bridge on a two-way road, a blind curve or sharp bend, a hill, etc.

In another embodiment, a group of R-CAS units form a coordinated network of controller nodes in a traffic system and method to intelligently control traffic through an area of interest (i.e. an approach zone and a control zone) in real time, and without any human intervention apart from initial setup and periodic maintenance. In between scheduled maintenance, the R-CAS units are designed to be self-sufficient and may be equipped with an environmentally friendly rechargeable power source, including solar arrays or feeds from other energy sources which charge onboard batteries.

Thus, with wireless communications between a plurality of R-CAS units coordinating traffic in an area of interest, using algorithms suitable for each type of traffic control application, the present system and method provides a cost effective, reliable, and viable solution to one of the leading causes of operational inefficiencies, financial losses, injuries, and fatalities for the various aforementioned industries, while keeping environmental impact to a minimum.

### BRIEF DESCRIPTION OF THE DRAWINGS

In the drawings, which form part of this specification,

FIG. 1 is a schematic diagram of an illustrative example of a traffic configuration and a traffic control system and method in accordance with an embodiment.

FIG. 2 is a schematic diagram of another illustrative example of a traffic configuration and a traffic control system and method in accordance with another embodiment of the present system and method.

FIG. 3 is a schematic diagram of another illustrative example of a traffic configuration and a traffic control system and method in accordance with another embodiment of the present system and method.

FIG. 4 is a schematic diagram of yet another illustrative example of a traffic configuration and a traffic control system and method in accordance with another embodiment of the present system and method.

FIG. 5 is a schematic flowchart of an illustrative traffic control algorithm in accordance with an embodiment.

FIG. 6 is a schematic flowchart of another illustrative traffic algorithm in accordance with an embodiment.

FIG. 7 is an illustrative view of a portable controller node in accordance with an embodiment.

FIG. 8 is a schematic block diagram of an illustrative control system with connections to external entities in accordance with an embodiment.

### DETAILED DESCRIPTION

As noted above, the present disclosure relates to a real-time traffic management system and method, and more particularly to a system and method for controlling the same.

In an aspect, the present system and method included different algorithms and control logic to determine when vehicles may enter and exit an approach zone, and when the vehicles are allowed to enter a control zone. The algorithms and control logic may also include routines or modules to maintain statistics for traffic passing through a control zone to ensure that safety rules are followed by the vehicles, and for improving efficiency.

In an embodiment, each roadside collision avoidance system (R-CAS) is a controller node in a network of controller nodes controlling traffic through a control zone. Controller nodes communicate with each other through wired or wireless communication. Each controller node detects when vehicles enter or leave the approach zone. This information is transmitted to all other controller nodes. Based on this information the control algorithm determines which vehicle will be allowed entry into the control zone.

In an embodiment, location tracking is used for deployment, security, and asset management. When a controller node is deployed, location information is used to ensure it is positioned correctly. If a controller node is moved without authorization, location information will identify the incident and help to locate the controller node. When an inventory of all deployed controller nodes is required, location information is used to identify where all deployed controller nodes are located.

In an embodiment, the system and method logs events and records video of all activity at a controller node. Events include, but are not limited to, approach zone entry/exits, control zone entry/exits, control zone entry violations, and approach zone U-turns. Video is recorded of all activity in the approach zone and/or the control zone when the approach zone and/or control zone are occupied. These events and video are used for, but not limited to, event reconstruction, security, and audit trail.

In an illustrative embodiment, each R-CAS unit is powered by a 12 volt battery or battery bank. The battery is charged by many possible energy sources. These sources may include, but are not limited to: electrical grid, solar panel, fuel cell, thermo-electric generator, gas or diesel powered generator and wind turbine.

In an embodiment, a camera is used for video recording of the approach zone and/or the control zone and for secondary vehicle detection. The camera has pan, tilt, and zoom capability, but for cost reduced installations, any or all of these controls may be omitted. The camera also has infra-red capability for proper night time functionality.

In another embodiment, communication from each R-CAS unit or controller node to an operations, administration, maintenance, and provisioning (OAM&P) server is achieved through a cellular modem, satellite modem, or wire line modem. The OAM&P server is used to manage and control all aspects of the R-CAS units including, but not limited to, deployment, configuration, monitoring (events and video), statistics, security, and status.

In an embodiment, the OAM&P server is used to configure each R-CAS unit for proper operation in the field. All operating parameters can be set, cleared, or verified by the OAM&P server. The OAM&P server can also perform a wireless software download to update the operating system and modify any operating parameters or control algorithm.

In an embodiment, the OAM&P server is also used to monitor the video or the events occurring at any controller node in real-time or from log files. The video and/or log files can be uploaded to the OAM&P server for further processing and analysis.

In another embodiment, the OAM&P server is also used to gather statistics. Statistics include, but are not limited to, approach zone entry/exit counts, control zone entry/exit counts, control zone entry violation counts, approach zone U-turn counts, control zone occupancy times, control zone traversal times, approach zone occupancy times, and approach zone traversal times. The OAM&P server is also used to maintain the security and status of a controller node. The location and other security and status information, such as, but not limited to, door open sensor, motion sensor, and component failures are transmitted to the OAM&P server for further processing and analysis.

Illustrative examples of the system and method will now be described with reference to the figures.

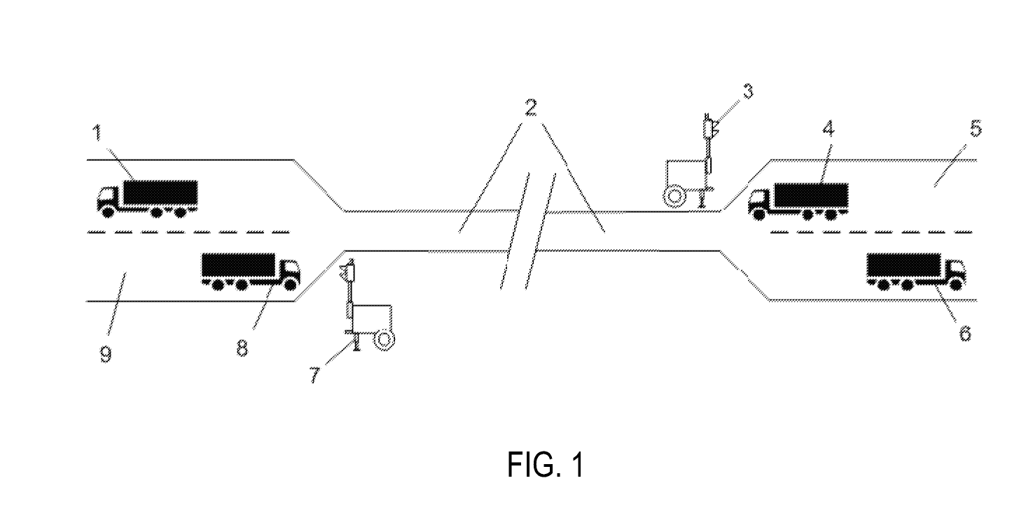

Now referring to FIG. 1, shown is a schematic diagram of an illustrative example of a traffic control area of interest in accordance with an embodiment of the present system and method. In this example, the present system and method is used to regulate vehicular traffic through a control zone 2 where a narrow road, single lane, lane closure, one-way bridge, or other physical impediment exists.

Controller nodes 3 and 7 controlling entry into the control zone 2 may comprise the R-CAS units as described further below. Although in this example, only two controller nodes 3 and 7 are shown, other embodiments of the invention may contain many controller nodes for controlling more complex traffic scenarios.

Still referring to FIG. 1, approach zones 9 and 5 define perimeter vehicle detection zones for their respective controller nodes. Outgoing vehicles 1 and 6 are shown in approach zones 9 and 5, respectively. Incoming vehicles 8 and 4 are shown in approach zones 9 and 5 respectively.

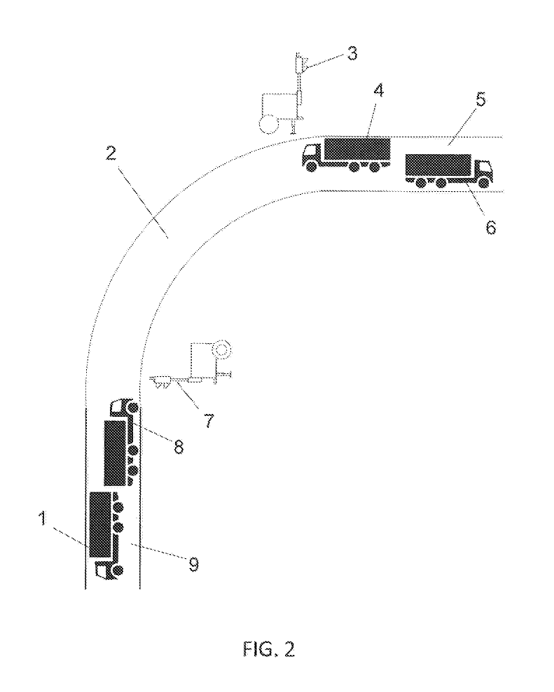

Now referring to FIG. 2, shown is a schematic diagram of another illustrative example of a traffic control area of interest in accordance with another embodiment of the present system and method. In this example, the present system and method is used to regulate vehicular traffic through a control zone 2 where a hill, blind corner, or other visual impediment which may pose a potential traffic hazard (such as a head-on collision) exists. Controller nodes 3 and 7 control traffic coming into the control zone 2 from two directions. Although in this example, only two controller nodes are shown, other embodiments may contain many controller nodes to control more complex traffic control areas of interest. Approach zones 9 and 5 define perimeter vehicle detection zones to provide early warning of oncoming vehicles entering the approach zones 9 and 5, and for confirmation of vehicle departures from the approach zones 9 and 5 for their respective controller nodes 7 and 3. Outgoing vehicles 1 and 6 are detected as they leave the approach zones 9 and 5, respectively to confirm that the road is clear in either direction in the approach zones 9 and 5. Incoming vehicles 8 and 4 are also detected as they enter approach zones 9 and 5 respectively towards the control zone 2.

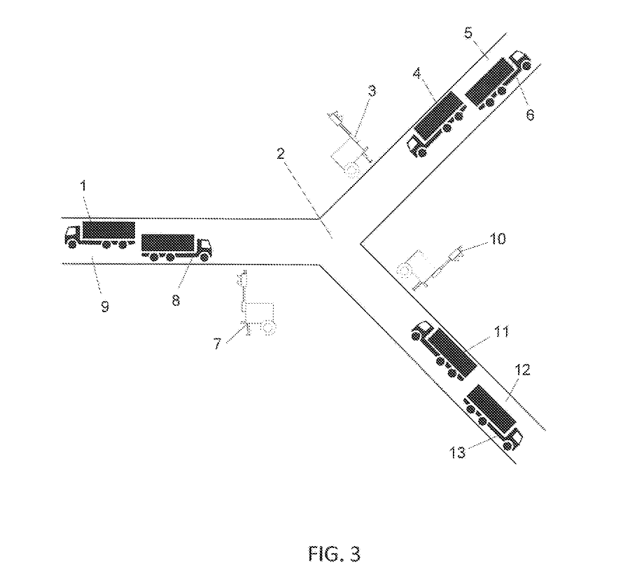

Now referring to FIG. 3, shown is a schematic diagram of another illustrative example of another traffic control area of interest controlled in accordance with another embodiment of the present system and method. In this example, the present system and method is used to regulate vehicular traffic through a control zone 2 consisting of a T-intersection, a fork in the road, or other type of intersection. Here, controller nodes 3, 7, and 10 control traffic entering the control zone 2 from all three directions. Although in this embodiment, only three controller nodes are shown, other embodiments may contain many controller nodes. Approach zones 9, 5, and 12 define perimeter vehicle detection zones for their respective controller nodes. Outgoing vehicles 1, 6, and 13 are detected by controller nodes 3, 7 and 10 as the outgoing vehicles leave the approach zones 9, 5 and 12, respectively. Incoming vehicles 8, 4 and 11 are detected by controller nodes 3, 7 and 10 as they enter the approach zones 9, 5 and 12 respectively.

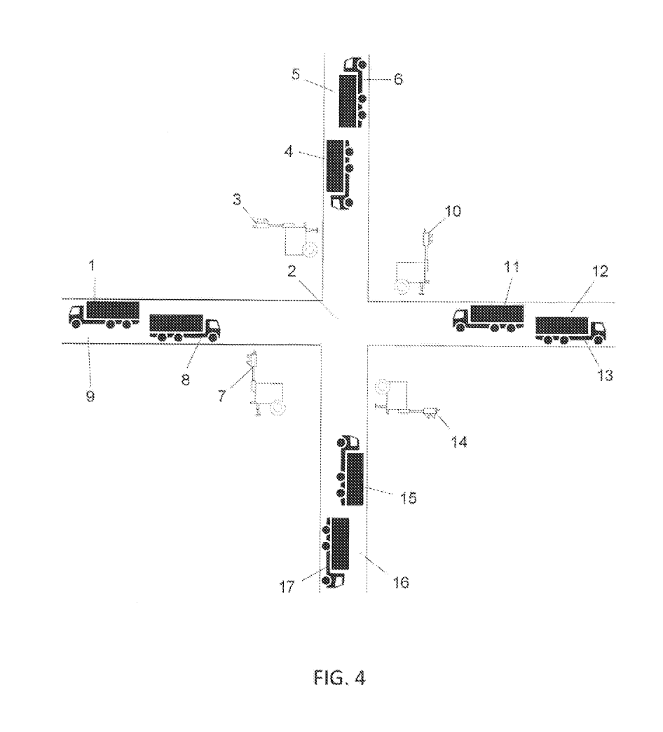

FIG. 4 shows a schematic diagram of yet another illustrative example of a traffic control area of interest controlled in accordance with another embodiment of the present system and method. In this example, the present system and method is used to regulate vehicular traffic through a control zone 2 consisting of a four-way intersection. Controller nodes 3, 7, 10, and 14 control traffic into control zone 2 as vehicles approach and leave the control zone 2 in all directions. Although four controller nodes are shown in this example, other embodiments may contain many controller nodes to control traffic approaching the control zone 2. Approach zones 9, 5, 12, and 16 perimeter vehicle detection zones for their respective controller nodes 7, 3, 10, 14. Outgoing vehicles 1, 6, 13 and 17 are detected by the controller nodes as they leave the approach zones. Incoming vehicles 8, 4, 11, and 15 are detected as they enter the approach zones.

While a limited number of traffic control areas of interest have been shown by way of example in FIGS. 1 to 4, it will be appreciated that the present system and method may be extended to cover virtually any traffic control area of interest having different road and hazard configurations.

To illustrate how traffic may be controlled in the traffic control areas of interest as shown by way of example in FIGS. 1 to 4 above, some non-limiting examples of control algorithms that may be used: by the present system and method are now described.

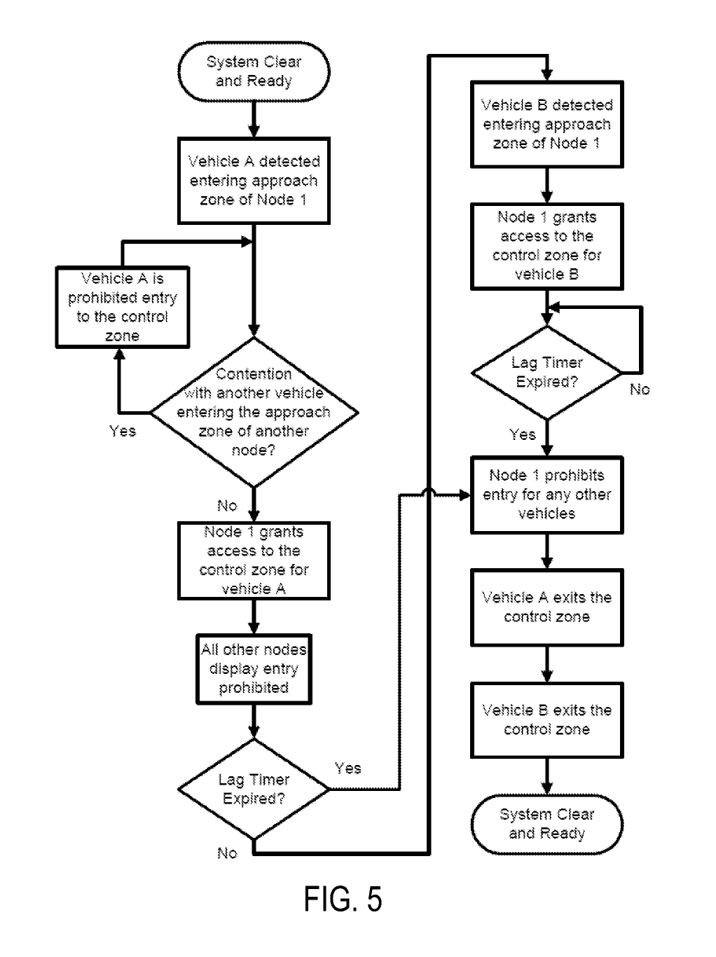

Referring to FIG. 5, shown is a schematic flowchart of an illustrative traffic control algorithm. In this example, a first vehicle approaches one controller node controlling traffic in one direction before another second vehicle approaches another node controller node controlling traffic in another direction. An illustrative example of the control steps may be as follows:
1. System is in the ready state.
2. Vehicle A enters approach zone of controller node 1 and no vehicles are queued at the approach zone of node 2.
3. Node 1 grants access to the control zone for vehicle A.
4. Node 2 denies access to the control zone for any vehicles entering the approach zone of node 2.
5. When the node 1 lag timer expires, node 1 denies access to the control zone for any other vehicles entering the approach zone of node 1.
6. Vehicle B enters approach zone of node 2 and is denied entry to the control zone.
7. Vehicle A exits the control zone.
8. Controller node 2 grants access to the control zone for vehicle B.
9. Controller node 1 denies access to the control zone for any vehicles entering the approach zone of node 1.
10. Vehicle B exits the control zone.
11. System returns to the ready state.

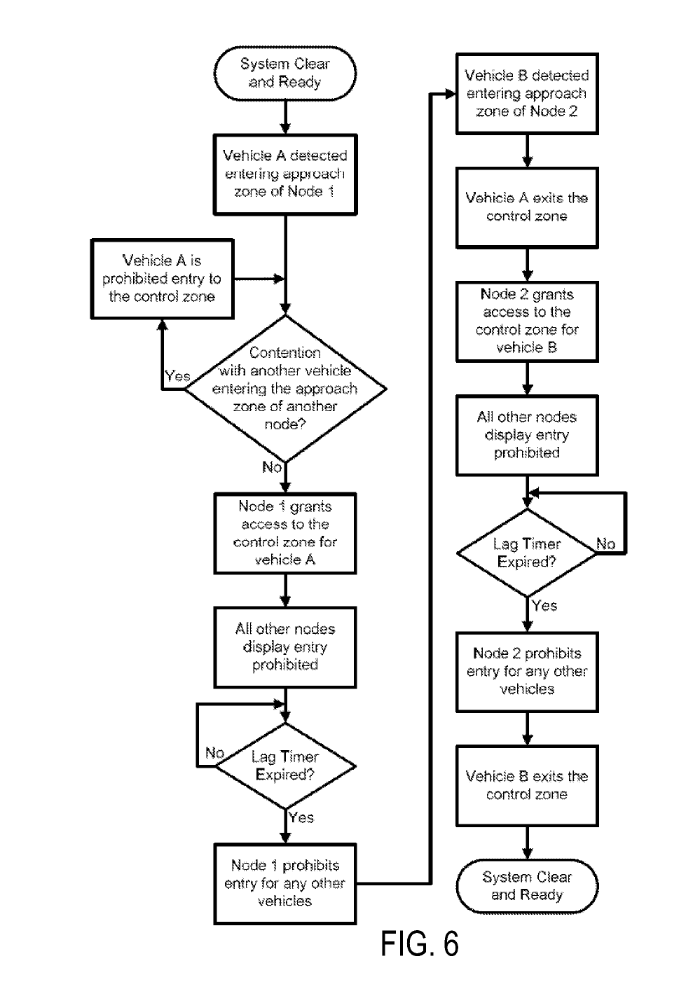

FIG. 6 is a schematic flowchart of another illustrative traffic control algorithm. In this example, a first vehicle enters a control zone of a controller node while a second vehicle following the first vehicle in the same direction has just entered the approach zone from the same controller node.
1. System is in the ready state.
2. Vehicle A enters the approach zone of controller node 1 when no vehicles are queued at the approach zone of controller node 2.
3. Controller node 1 grants access to the control zone for vehicle A.
4. Controller node 2 denies access to the control zone for any vehicles entering the approach zone of controller node 2.
5. Before the controller node 1 lag timer expires, vehicle B enters the approach zone of controller node 1.
6. Controller node 1 continues to grant access to the control zone for vehicle B.
7. When the controller node 1 lag timer expires, controller node 1 denies access to the control zone for any other vehicles entering the approach zone of controller node 1.
8. Vehicle A exits the control zone; vehicle B exits the control zone.
9. System returns to the ready state.

The above control algorithms are provided as relatively simple illustrative embodiments. However, it will be appreciated that the control algorithms may be significantly more complex to deal with road configurations requiring control of more vehicles on more roads approaching a control zone.

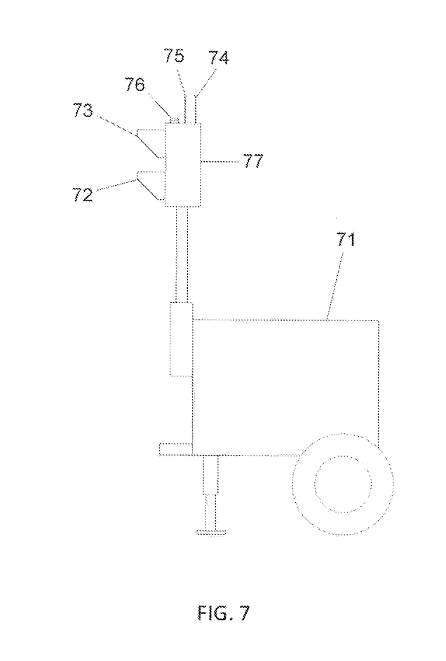

Now referring to FIG. 7, shown is an illustrative view of a portable R-CAS unit in accordance with an embodiment. In this example, deployment vehicle 71 is a mobile unit which may be transported to any location requiring traffic control. Signal lights 72 and 73 are provided on the R-CAS unit to provide traffic light signals to oncoming vehicles. Although only two lights are shown in this example, any number of lights (e.g. 1, 2, 3, or 4) may be used to control oncoming traffic.

In an embodiment, each R-CAS unit includes an inter-node radio antenna 74 which is adapted to allow wireless local area, network (WLAN) communications between the various R-CAS units deployed as, controller nodes in a given traffic control area of interest. In another embodiment, a cellular/Wi-Fi/Bluetooth/Zigbee/satellite antenna 75 is provided to allow each R-CAS unit to communicate over longer distances to a remote control centre (not shown). Other embodiments of the R-CAS unit may include these antennas as separate modules or components.

In another embodiment, the R-CAS unit may include a GPS antenna 76 to track the geographic location of the R-CAS unit. This geographic location of each R-CAS unit may be used to position each R-CAS unit on a virtual map of the traffic control area of interest without having to manually keep track of the units.

In another embodiment, the R-CAS unit includes a light head 77 containing the signal lights 72 and 73. Other possible deployment methods are pole mounted, stationary ground, and vehicle mounted units.

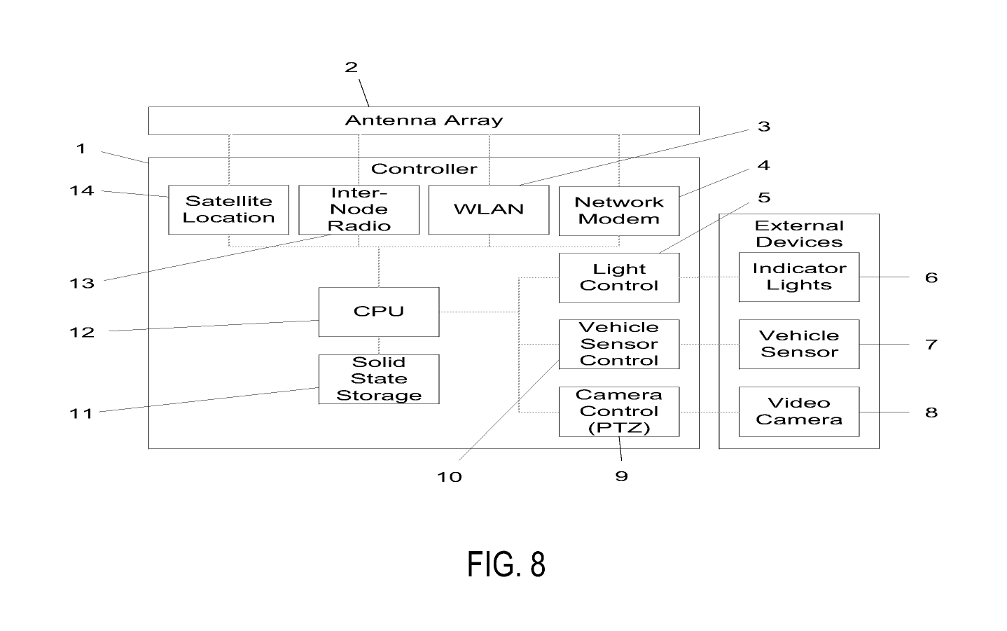

FIG. 8 shows a schematic block diagram of an illustrative control module 81 with connections to external entities in accordance with an embodiment. Shown are antennas 82 which correspond to the various types of antennas described in FIG. 7, above. A WLAN module 83 is used for local wireless are network access for a group of traffic controller nodes set up in a traffic area of interest. In an embodiment, a data network modem module 84 is used for connection to the internet. A light control module 85 is used to control the lights based on a suitable traffic control algorithm as described above.

In an embodiment, indicator lights 86 contain a light head. Other embodiments may contain multiple light heads.

In another embodiment, a vehicle sensor 87 is used to detect approaching and departing vehicles. Various types of vehicle sensor technologies may be used including radar. A vehicle sensor control module 810 used to control the vehicle sensor.

In another embodiment, video camera 88 is used to record vehicular traffic, or alternatively for secondary vehicle detection utilizing vision processing. Camera control module 89 used to control the camera.

In another embodiment, a storage module 811 is used to store all video, logs, alarms, events, and computer codes. Control module 812 performs all computational processing tasks. Inter-node radio module 813 controls communication between controller nodes in a WLAN. Satellite location tracking module 814 is used to geographically locate each R-CAS module. Also, the geographic location of each controller node can be used to appropriately configure a traffic control area of interest based on the relative position of each controller node within the traffic control area of interest.

As will be appreciated from the above illustrative examples, the present system and method may be embodied in many different forms, and the types of traffic control areas of interest that may be addressed is virtually unlimited as the controller nodes can be mobile and are positionable in virtually any number and in any physical configuration.

Thus, in an aspect, there is provided a computational device for controlling vehicular access to a restricted area comprising a vehicle detection device and a visual signaling device, the computational device comprising a control module, data storage module, satellite location tracking receiver module, inter-node radio module, Wireless Local Area Network (WLAN) radio module, cellular radio module, satellite radio module, light control module, vehicle detector control module, and camera control module, the computational device comprising algorithms and control logic for the purpose of vehicle control and monitoring. The vehicular access can include access for trucks, cars, vans, motorcycles, bicycles, etc.

The vehicle detection module can be a device which utilizes radar, microwave, sonar, video, light beam, laser beam, inductive burial loop, audio, or strobe detection. The vehicle detection device is capable of detecting vehicles traveling in both an approaching and departing direction.

In another embodiment, the system can include audio and strobe detection for emergency vehicle detection, in which case the system can provide priority right-of-way for the emergency vehicles.

The visual signaling device can include conventional red, green, and yellow lights, including solid lights and arrows and flashing lights with different duty cycles.

The control module can include a central processing unit (CPU), digital signal processor (DSP), application specific integrated circuit (ASIC), or other electronic control device.

The data storage module can be a hard disk drive, solid state drive, optical media drive, flash memory drive, floppy disk drive, tape drive, or other mass storage device.

The satellite location tracking receiver module can be a Global Positioning System (GPS), Global Navigation Satellite System (GLONASS), Galileo, Compass, Indian Regional Navigational Satellite System (IRNSS) or other satellite based location tracking device.

The inter-node radio module can be a bi-directional data radio module operating in an unlicensed or licensed band, the radio module Comprised of 900 MHz, Wi-Fi, Bluetooth, Zigbee, cellular, satellite, or other wireless communication protocols.

The inter-node radio module can be replaced with serial data via twisted pair, differential pair, Ethernet, RS-232, RS422, RS-485, and Modbus wired communication.

The WLAN radio module can be a wireless data module utilizing Wi-Fi, Bluetooth, Zigbee, or other wireless data communication protocols.

The cellular radio module can be a cellular radio capable of Cellular Digital Packet Data (CDPD), Time Division Multiple Access (TDMA), Code Division Multiple Access (CDMA), General Packet Radio Service (GPRS), Enhanced Data Rates for GSM Evolution (EDGE), Universal Mobile Telecommunications Service (UMTS), Wideband Code Division Multiple Access (WCDMA), High Speed Packet Access (HSPA), High Speed Downlink Packet Access (HSDPA), Evolution Data Optimized (EVDO), Worldwide Interoperability for Microwave Access (WiMAX), Long Term Evolution (LTE), or other cellular data protocols.

The satellite radio module can be a satellite radio capable of Celestri, Equatorial Constellation Communications Organization (ECCO), Ellipso, Globalstar, ICO, IRIDIUM, Orbcomm, Inmarsat, Project Horizons, SkyBridge, Spaceway, Teledesic, or other mobile satellite services protocols.

The light control module can be a serial or parallel data port capable of addressing individual control lines and turning on or off the control lines.

The vehicle detector control module can be a serial or parallel data port capable of controlling the vehicle detection device.

The camera control module can be a serial or parallel data port capable of controlling a video capture device wherein the controls consists of brightness, contrast, hue, saturation, aperture, frame rate, resolution, encoding, pan, tilt, or zoom functions.

The algorithms and control logic can be a series of computational decisions that control the visual signaling device. For example, the computational decisions can determine when a vehicle enters or exits the approach zone, or when a vehicle is allowed to enter the control zone.

The control zone entry decisions can be time of entry into the approach zone. The control zone entry decisions can also be based on mode of operation. For example, the mode of operation can be a first-come first-served mode, wherein the first vehicle entering the approach zone will be allowed entry into the control zone. As another example, the mode of operation can be timed interval mode, wherein each controller node will be given a specific period of time to allow vehicles to enter the control zone. In another example, the mode of operation consists of an alternating mode, wherein each controller node allows one vehicle to enter the control zone before passing control to the next controller node. In another further example, the mode of operation consists of a right-of-way mode, wherein vehicles at one controller node will be granted right-of-way over vehicles at all other controller nodes regardless of any vehicles approach zone entry time. In still another example, the control zone entry decisions can be based on the urgency status of the vehicle. The urgency status can be determined by emergency vehicle detection.

The computational decisions can be based on collection of statistics to ensure safety rules are being followed. The collected statistics can also be used to improve vehicular throughput.

Thus, in an aspect, there is provided a computer-implemented system for controlling vehicular traffic in an area of interest, comprising: a plurality of positionable controller nodes adapted to wirelessly communicate with each other controller node, each controller node including: a vehicle detection module; a visual signaling module; an inter-node radio module; and a control module; wherein the plurality of positionable controller nodes are positioned based on a traffic configuration in the area of interest and adapted to execute a traffic control algorithm to generate a right-of-way sequence for controlling vehicular traffic in the area of interest.

In an embodiment, the inter-node radio module is adapted to establish a wireless local area network.

In another embodiment, the plurality of positionable controller nodes are mobile.

In another embodiment, the right-of-way sequence is communicated utilizing the visual signaling module and a sequence of traffic lights.

In another embodiment, the vehicle detection module comprises one or more of radar, microwave, sonar, video, light beam, laser beam, inductive burial loop, audio, and strobe detection.

In another embodiment, the vehicle detection module is adapted to detect vehicles approaching and departing the area of interest.

In another embodiment, each controller node further comprises a camera module for recording all vehicles approaching and departing the area of interest.

In another embodiment, each controller node is further adapted to detect vehicles approaching and departing the area of interest utilizing image processing on images recorded by the camera module.

In another embodiment, each controller node is further adapted to collect statistical information utilizing image processing on images recorded by the camera module to verify that traffic safety rules are being followed.

In another embodiment, each controller node further comprises a satellite location tracking module for tracking the location of each controller node within an area of interest, and provisioning each controller node in dependence upon their location in the area of interest.

In another aspect, there is provided a computer-implemented method for controlling vehicular traffic in an area of interest, comprising: providing a plurality of positionable controller nodes adapted to wirelessly communicate with each other controller node, each controller node including: a vehicle detection module; a visual signaling module; an inter-node radio module; and a control module; positioning the plurality of positionable controller nodes based on a traffic configuration in the area of interest; and executing a traffic control algorithm to generate a right-of-way sequence for controlling vehicular traffic in the area of interest.

In an embodiment, the inter-node radio module is adapted to establish a wireless local area network.

In another embodiment, the plurality of positionable controller nodes are mobile.

In another embodiment, the method further comprises communicating the right-of-way sequence utilizing the visual signaling module and a sequence of traffic lights.

In another embodiment, the vehicle detection module comprises one or more of radar, microwave, sonar, video, light beam, laser beam, inductive burial loop, audio, and strobe detection.

In another embodiment, the method further comprises detecting vehicles approaching and departing the area of interest utilizing the vehicle detection module.

In another embodiment, each controller node further comprises a camera module for recording all vehicles approaching and departing the area of interest.

In another embodiment, the method further comprises detecting vehicles approaching and departing the area of interest utilizing image processing on images recorded by the camera module.

In another embodiment, the method further comprises collecting statistical information utilizing image processing on images recorded by the camera module to verify that traffic safety rules are being followed.

In another embodiment, the method further comprises tracking the location of each controller node within an area of interest utilizing a satellite location tracking module; and provisioning each controller node in dependence upon their location in the area of interest.

While the above description provides examples of one or more embodiment and methods, it will be appreciated that other embodiments and methods may be within the scope of the present description as interpreted by one of skill in the art.

1. A computer-implemented system for controlling vehicular traffic in an area of interest, comprising:
a plurality of positionable controller nodes adapted to wirelessly communicate with each other controller node, each controller node including:
a vehicle detection module;
a visual signaling module;
an inter-node radio module; and
a control module;
wherein the plurality of positionable controller nodes are positioned based on a traffic configuration in the area of interest and adapted to execute a traffic control algorithm to generate a right-of-way sequence for controlling vehicular traffic in the area of interest.

2. The computer-implemented system of claim 1, wherein the inter-node radio module is adapted to establish a wireless local area network.

3. The computer-implemented system of claim 1, wherein the plurality of positionable controller nodes are mobile.

4. The computer-implemented system of claim 1, wherein the right-of-way sequence is communicated utilizing the visual signaling module and a sequence of traffic lights.

5. The computer-implemented system of claim 1, wherein the vehicle detection module comprises one or more of radar, microwave, sonar, video, light beam, laser beam, inductive burial loop, audio, and strobe detection.

6. The computer-implemented system of claim 5, wherein the vehicle detection module is adapted to detect vehicles approaching and departing the area of interest.

7. The computer-implemented system of claim 1, wherein each controller node further comprises a camera module for recording all vehicles approaching and departing the area of interest.

8. The computer-implemented system of claim 7, wherein each controller node is further adapted to detect vehicles approaching and departing the area of interest utilizing image processing on images recorded by the camera module.

9. The computer-implemented system of claim 7, wherein each controller node is further adapted to collect statistical information utilizing image processing on images recorded by the camera module to verify that traffic safety rules are being followed.

10. The computer-implemented system of claim 1, wherein each controller node further comprises a satellite location tracking module for tracking the location of each controller node within an area of interest, and provisioning each controller node in dependence upon the controller node's location in the area of interest.

11. A computer-implemented method for controlling vehicular traffic in an area of interest, comprising:
providing a plurality of positionable controller nodes adapted to wirelessly communicate with each other controller node, each controller node including:
a vehicle detection module;
a visual signaling module;
an inter-node radio module; and
a control module;
positioning the plurality of positionable controller nodes based on a traffic configuration in the area of interest; and
executing a traffic control algorithm to generate a right-of-way sequence for controlling vehicular traffic in the area of interest.

12. The computer-implemented method of claim 11, wherein the inter-node radio module is adapted to establish a wireless local area network.

13. The computer-implemented method of claim 11, wherein the plurality of positionable controller nodes are mobile.

14. The computer-implemented method of claim 11, further comprising communicating the right-of-way sequence utilizing the visual signaling module and a sequence of traffic lights.

15. The computer-implemented method of claim 11, wherein the vehicle detection module comprises one or more of radar, microwave, sonar, video, light beam, laser beam, inductive burial loop, audio, and strobe detection.

16. The computer-implemented method of claim 15, further comprising detecting vehicles approaching and departing the area of interest utilizing the vehicle detection module.

17. The computer-implemented method of claim 11, wherein each controller node further comprises a camera module for recording all vehicles approaching and departing the area of interest.

18. The computer-implemented method of claim 7, further comprising detecting vehicles approaching and departing the area of interest utilizing image processing on images recorded by the camera module.

19. The computer-implemented method of claim 17, further comprising collecting statistical information utilizing image processing on images recorded by the camera module to verify that traffic safety rules are being followed.

20. The computer-implemented method of claim 11, further comprising:
tracking the location of each controller node within an area of interest utilizing a satellite location tracking module; and
provisioning each controller node in dependence upon the controller node's location in the area of interest.
